(19) United States
(12) Patent Application Publication
(10) Pub. No.: US 2009/0326728 A1
(43) Pub. Date: Dec. 31, 2009

(54) SYSTEMS AND METHODS FOR CONTROLLING POWER USAGE ON A DEVICE

(75) Inventors: Roy K. Chrisop, Camas, WA (US); Andrew Rodney Ferlitsch, Camas, WA (US)

Correspondence Address: AUSTIN RAPP & HARDMAN, 170 SOUTH MAIN STREET, SUITE 735, SALT LAKE CITY, UT, 84101, US

(73) Assignee: Sharp Laboratories of America, Inc., Camas, WA (US)

(21) Appl. No.: 12/163,729

(22) Filed: Jun. 27, 2008

(51) Int. Cl. G06F 19/00

(52) U.S. Cl. 700/295

(57) ABSTRACT

A method for controlling power usage on a device is described. A job is received at a device. The job is classified as an on-demand job or as a non-on-demand job. The job is placed on an on-demand job queue if the job is an on-demand job. The job is placed on a non-on-demand job queue if the job is a non-on-demand job. The on-demand job queue is processed. The non-on-demand job queue is processed only during an off-peak period.

### TECHNICAL FIELD

The present invention relates generally to electronic devices and computer-related technology. More specifically, the present invention relates to systems and methods for controlling power usage on a device.

### BACKGROUND

Computer and communication technologies continue to advance at a rapid pace. Indeed, computer and communication technologies are involved in many aspects of a person's day. For example, many devices being used today by consumers have a small computer incorporated within the device. These small computers come in varying sizes and degrees of sophistication. These small computers may vary in sophistication from one microcontroller to a fully-functional complete computer system. For example, small computers may be a one-chip computer, such as a microcontroller, a one-board type of computer, such as a controller, a typical desktop computer, such as an IBM-PC compatible, etc.

Printers are used with computers to print various kinds of items including letters, documents, pictures, etc. Many different kinds of printers are commercially available. Ink jet printers and laser printers are fairly common among computer users. Ink jet printers propel droplets of ink directly onto the paper. Laser printers use a laser beam to print.

Printers are a type of imaging device. Imaging devices include, but are not limited to, physical printers, multi-functional peripherals, a printer pool, a printer cluster, a fax machine, a plotter, a scanner, a logical device, an electronic whiteboard, a tablet PC, a computer monitor, a file, etc.

Different kinds of computer software facilitate the use of imaging devices. The computer or computing device that will be used to print the materials typically has one or more pieces of software running on the computer that enable it to send the necessary information to the printer to enable printing of the materials. If the computer or computing device is on a computer network there may be one or more pieces of software running on one or more computers on the computer network that facilitate printing.

Imaging devices, computing devices and other electronic devices all use power for operation. In some situations, it may be desirable to save power, while at other times the use of power may not be a concern. Benefits may be realized by providing improved systems and methods for controlling power usage on a device.

### BRIEF DESCRIPTION OF THE DRAWINGS

FIG. 1 is a block diagram illustrating one configuration of a system for regulating power usage for a device;

FIG. 2 is one configuration of a method for a device operating with a peak/off-peak controller;

FIG. 3 is one configuration of a method for a peak/off-peak controller;

FIG. 4 is a block diagram illustrating one configuration of an MFP device with power usage regulation;

FIG. 5 is one configuration of a method for determining the type of job that has been submitted to a device;

FIG. 6 is a block diagram of one configuration of an MFP device operating in a peak period;

FIG. 7 is a block diagram of one configuration of an MFP device operating in an off-peak period;

FIG. 8 is a block diagram illustrating one configuration of an MFP device communicating with the power utility to determine on-demand rates and schedules;

FIG. 9 is a block diagram illustrating the major hardware components typically utilized with embodiments herein; and

FIG. 10 is a network block diagram illustrating one possible environment in which the present systems and methods may be implemented

### DETAILED DESCRIPTION

A method for controlling power usage on a device is described. A job is received at a device. The job is classified as an on-demand job or as a non-on-demand job. The job is placed on an on-demand job queue if the job is an on-demand job. The job is placed on a non-on-demand job queue if the job is a non-on-demand job. The on-demand job queue is processed. The non-on-demand job queue is processed only during an off-peak period.

In one configuration, a peak/off-peak signal may be received to identify a peak period or an off-peak period. The peak/off-peak signal may be received from a local power grid. The peak/off-peak signal may be decoded.

The device may be a multifunction peripheral device. The job may be a print job, a copy job, or a facsimile job.

In one implementation, classifying the job may include calculating a job size. In addition, classifying the job may further include comparing the job size with a threshold.

In another configuration, rates relating to the cost of power usage may be received via a computer network. A current period may be set as a peak period or an off-peak period based on the rates received. Moreover, a schedule may be set for peak periods and off-peak periods based on the rates received. The schedule may be used to determine if a current period is a peak period or an off-peak period.

A multifunctional peripheral (“MFP”) device that is configured for power usage control is also described. The MFP device includes a processor and memory in electronic communication with the processor. Executable instructions are stored in the memory. A job is received. The job is classified as an on-demand job or as a non-on-demand job. The job is placed on an on-demand job queue if the job is an on-demand job. The job is placed on a non-on-demand job queue if the job is a non-on-demand job. The on-demand job queue is processed. The non-on-demand job queue is processed only during an off-peak period.

A computer-readable medium for controlling power usage on a device is also described. The computer-readable medium comprises executable instructions. A job is received at a device. The job is classified as an on-demand job or as a non-on-demand job. The job is placed on an on-demand job queue if the job is an on-demand job. The job is placed on a non-on-demand job queue if the job is a non-on-demand job. The on-demand job queue is processed. The non-on-demand job queue is processed only during an off-peak period.

Several exemplary configurations are now described with reference to the Figures. This detailed description of several configurations, as illustrated in the Figures, is not intended to limit the scope of the claims.

The word “exemplary” is used exclusively herein to mean “serving as an example, instance or illustration.” Any configuration described as “exemplary” is not necessarily to be construed as preferred or advantageous over other configurations.

This present systems and methods relate to power management of an electronic device. Different kinds of electronic devices may benefit from the systems and methods disclosed herein. For example, systems and methods herein may relate to power management of a multifunction peripheral (MFP) device, in an environment where power usage may be regulated into peak and off-peak periods. Such regulation may be local or state mandated with execution performed by the power utilities which provide power to the local power grids.

Currently, trial runs of state and utility regulated power use are being conducted in the state of California. While these trial runs are with volunteer customers, eventually California may deploy and enforce power regulation during peak power usage periods.

One system for regulating power usage may use a signal that is sent over the power grid. The signal may be used to indicate periods of peak and off-peak power regulation. The signal travels along the power lines within the residential and commercial users, and can be detected via the power supplies of devices in the home/business that are connected to the power system. The devices that detect this signal may be household appliances that are heavy users of power when operating, but operate generally as non on-demand devices. Examples of these household appliances include washing machines, clothes dryers, and dishwashers.

The system mentioned above may operate generally as follows. A power controller may be added to the device which decodes the peak/off-peak signal. During peak periods, the power controller disables the appliance from performing its function, but may otherwise be operable such as to set the function (e.g., wash) settings. During off-peak periods, the power controller enables the appliance allowing it to perform its function.

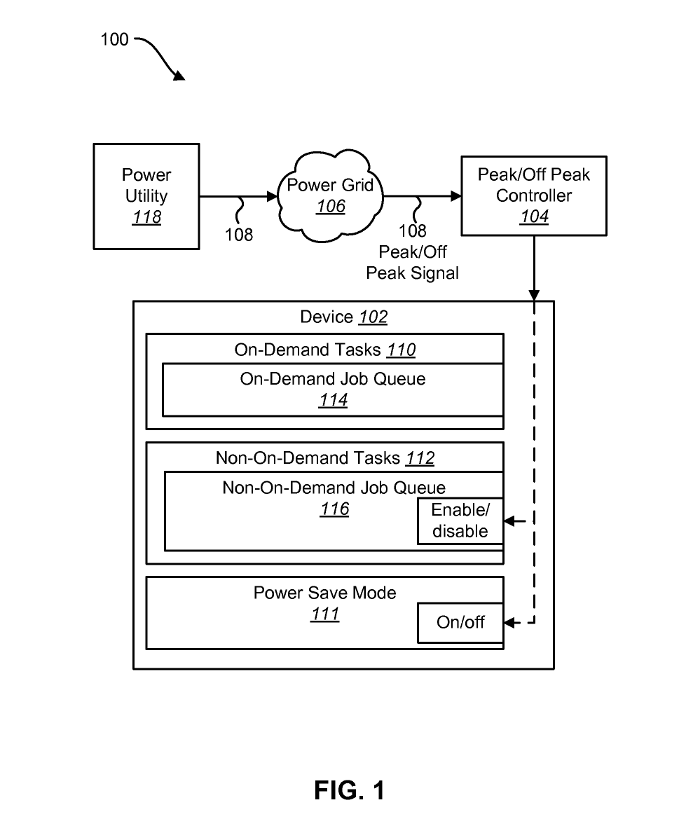

FIG. 1 is a block diagram illustrating one configuration of a system 100 for regulating power usage for a device 102. A suitable operating environment for this system 100 may include a business or residence that deploys at least one device 102. The present systems and method may be used with a wide variety of different kinds of devices 102. One type of device 102 that may use and benefit from the present systems and methods is an MFP device for performing hardcopy outputting (e.g., printing, copying, etc). Many devices 102 may be deployed that take advantage of the present systems and methods. The one or more devices 102 may perform a variety of job needs for users. These job needs may be classified as being either on-demand or non-on-demand jobs or tasks.

On-demand jobs for an MFP device typically include short print runs, such as memo printing, customer invoice, etc. These activities are needed for the daily operation of the business. On-demand jobs or tasks thus are needed in order to assist the business or residence in running or operating. If an on-demand job or task could not be performed when requested, it may hinder the efficient operation of the business or residence. Other jobs, while required, due not have an immediate time dependency. These tend to be larger print runs, such as printing multiple copies of training material for a training session that will be held at some subsequent future time. These non-on-demand jobs or tasks may be performed later because such a delay would not hinder the efficient operation of the business or residence. The determination of whether a job or task was an on-demand job or a non-on-demand job may be made by different entities such as the local government, state government, federal government, the business owner, the head of the residence, etc. The criteria for determining whether a job or task was an on-demand job or a non-on-demand job may thus change over time, may be based on objective factors, may be based on subjective factors, etc.

In the present systems and methods, jobs presented for submission to the device 102 may be classified as either on-demand jobs 110 or tasks 110 or non-on-demand jobs 112 or tasks 112. Depending on the job's classification, the job may be placed on either a regular (on-demand) job queue 114, or on a separate off-peak (non-on-demand) job queue 116.

A peak/off-peak signal 108 may be received and decoded from the power grid 106. The decoding may occur in the device 102 or in an external controlling device 104. Although FIG. 1 illustrates an external controller 104, the functionality of the controller 104 may be implemented within the device 102.

The peak/off-peak signal 108 may indicate when it is considered to be a peak time and when it is considered to be an off-peak time. During peak times energy demands are typically higher, and, as a result, deferring use of power to a later time may be encouraged and/or desirable. Off-peak times are times when energy demands are typically lower, and, as a result, the use of power during this off-peak time instead of during a peak time is encouraged.

When the signal 108 is decoded as a peak period, the controller 104 may disable processing of jobs from the non-on-demand (off-peak) job queue 116, while allowing jobs to be executed from the on-demand (regular) job queue 114. When the signal 108 is decoded as an off-peak period, the controller 104 may enable the joint processing of jobs from both the on-demand (regular) 114 and non-on-demand (off-peak) job queues 116.

The present systems and methods thus address devices 102 that operate in a mixed need mode (devices that have some tasks/jobs that need to be performed on-demand and some tasks/jobs that may be performed at a later time). In contrast, other systems have treated devices or appliances as either wholly being on-demand (e.g., refrigerator) and cannot be regulated, or wholly non-on-demand (e.g., washer) and can be arbitrarily regulated.

The present systems and methods may be beneficial for peripheral devices 102 that may receive jobs which are either on-demand and non-on-demand jobs. The peripheral device 102 may be programmed to disable non-on-demand job execution during peak hours, while preserving execution of on-demand jobs even during peak hours.

The device may perform both on-demand tasks/jobs 110 and non-on-demand tasks/jobs 112. The non-on-demand tasks 112 are presumed to generally be more power consuming than the on-demand tasks 110. The peripheral device 102 may include an on-demand job queue 114 for on-demand tasks 110. A non-on-demand job queue 116 may also be included as part of a device 102 for non-on-demand tasks 112.

The device 102 may also include a power save mode setting 111. In one configuration, the peak/off-peak signal 108 may be decoded and used for the power save mode setting 111. If the signal is a peak period, the power save mode setting 111 may be set to ON to indicate that the device 102 should defer non-on-demand tasks until later. If the signal is an off-peak period, the power save mode setting 111 may be set to OFF to indicate that the device 102 may process tasks including both on-demand and non-on-demand tasks.

As mentioned, MFP devices may use the present systems and methods. Due to fusing requirements in laser printers, these devices can consume a significant amount of power during the hardcopy outputting process. Thus, print/copy/fax-jobs which are short (e.g., 1 page) use nominal power when compared to long print jobs (e.g., multiple copy multi-page jobs).

The residential, commercial or other business enterprise may operate in a power usage regulated environment. In one possible operating environment, power usage may be regulated via a signal 108 which is generated at a power utility 118, passed through the local power grid 106 and decoded by power consuming devices 102. This signal 108 indicates whether the power usage in the local power grid 106 is operating in a peak or non-peak period. A peak/off-peak controller 104 may receive that peak/off-peak signal 108 from the power utility 118 through the power grid 106 in order to control on-demand tasks 110 and/or non-on-demand tasks 112.

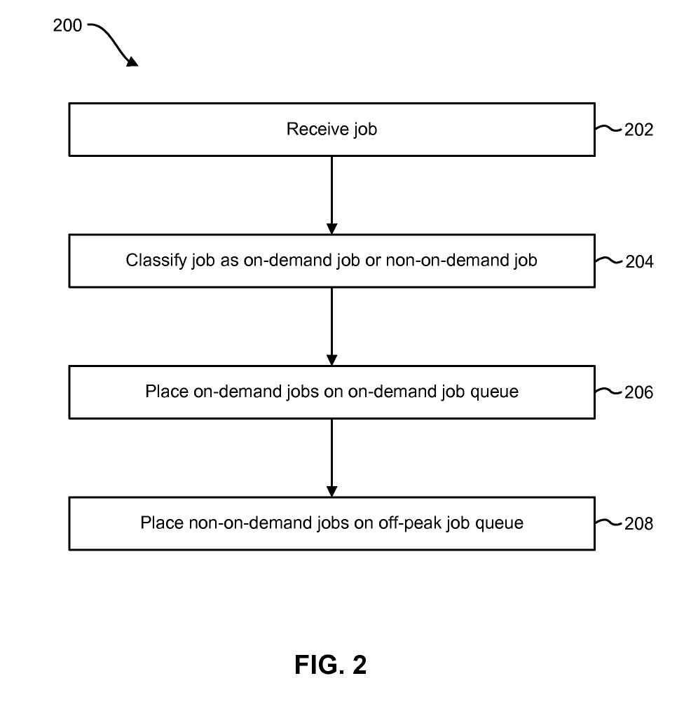

FIG. 2 is one configuration of a method 200 for a device operating with a peak/off-peak controller. A job may be received 202. The job may be any kind of job that can be performed by a device. For example, the job may be a print job, a copy job, a facsimile received, a task to turn on a device, a task to turn off a device, etc. Once the job is received 202, it may be classified 204 as either an on-demand job or a non-on-demand job. On-demand jobs are jobs where the device is expected to perform the job immediately or relatively soon. Non-on-demand jobs are jobs that can be placed in a queue and held until a later time, at which time the job may then be performed. On-demand jobs may be placed 206 on an on-demand job queue. Non-on-demand jobs may be placed 208 on an off-peak queue.

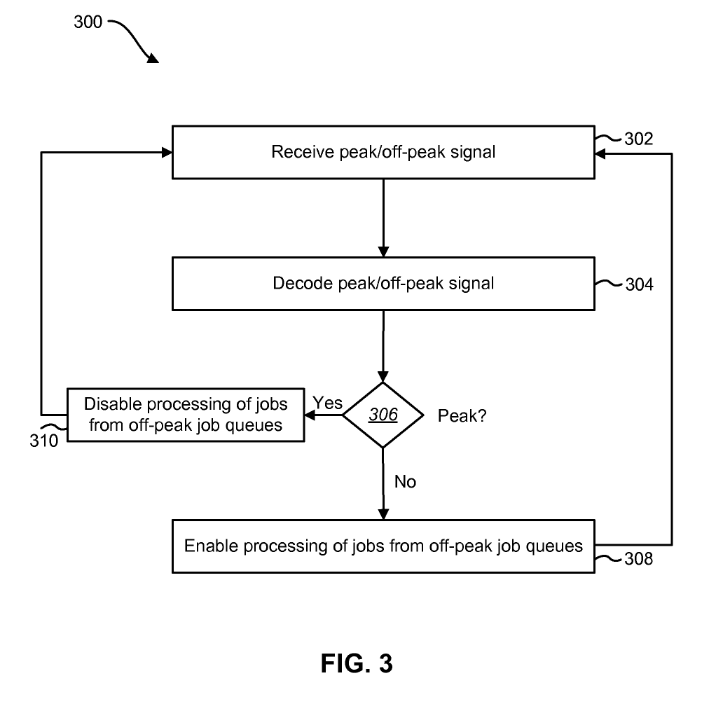

FIG. 3 is one configuration of a method 300 for a peak/off-peak controller. The peak/off-peak controller may receive 302 a peak/off-peak signal. The peak/off-peak signal may be sent to instruct the controller and/or devices to either switch to peak mode or off-peak mode. The peak/off-peak signal may be decoded 304. If the peak/off-peak signal indicates 306 that it is a peak time, the controller may disable 310 the processing of jobs from off-peak job queues. If the peak/off-peak signal indicates 306 that it is not a peak time, the controller may enable 308 the processing of jobs from off-peak job queues.

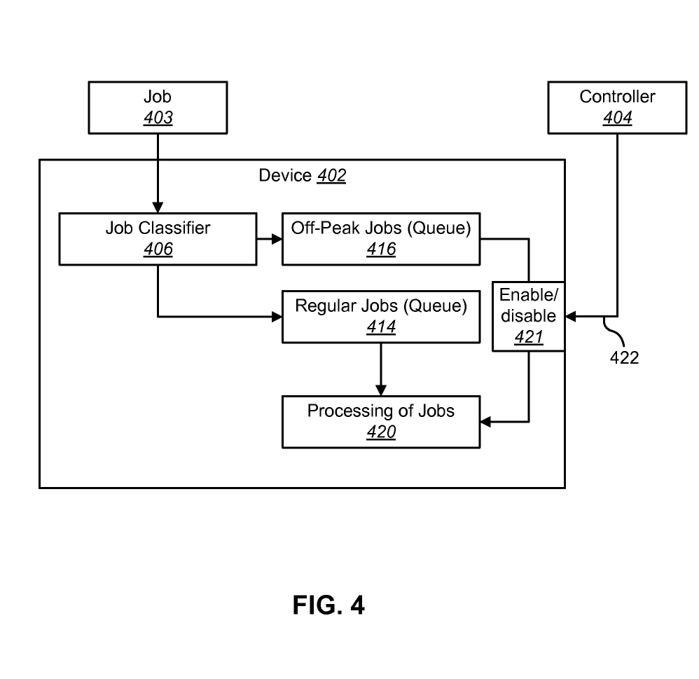

FIG. 4 is a block diagram illustrating one configuration of an MFP device 402 with power usage regulation. When a print, copy job or facsimile reception 403 is submitted to a printer/copier 402, a determination may be made by a job classifier module 406 as to whether the job is to be classified as an on-demand job or non-on-demand job.

In the case of a print job or facsimile reception, the determination is typically made after the softcopy document has been processed into print data. The determination may be made in part based on the contents of the print data. In the case of a copy job, the determination may be made after the hardcopy document has been scanned and converted to image data. The determination may be made in part based on the contents of the image data and copier settings.

After a job 403 is classified as either on-demand (regular) or non-on-demand (off-peak) job, the job data is then placed on a queue 414, 416, pending release to the hardcopy outputting engine. In the case of a job classified as on-demand, the print (or image data+copier settings) data may be placed on the on-demand (regular) job queue 414; otherwise, the print data (or image data+copier settings) may be placed on the non-on-demand (off-peak) queue 416.

The jobs 403 may be processed 420 in whatever manner the device 402 normally processes jobs 403 from either of the queues 414, 416. Jobs 403 from the off-peak job queue 416 may be regulated by the controller 404 sending a control signal 422 to enable/disable 421 jobs being sent for processing 420.

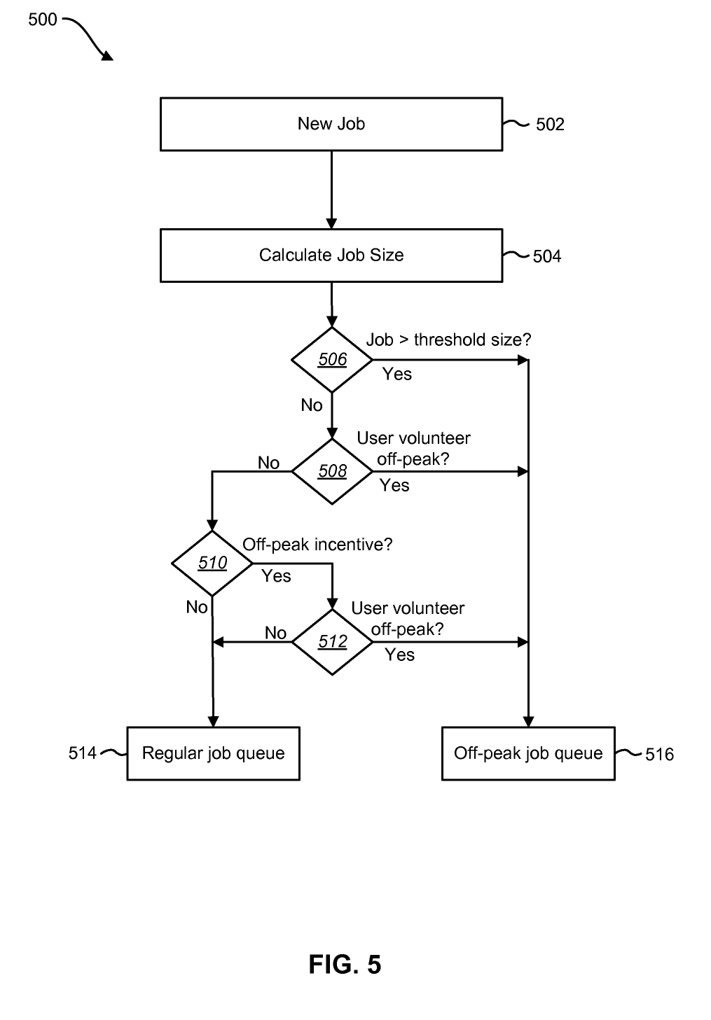

FIG. 5 is one configuration of a method 500 for determining the type of job that has been submitted to a device. When a new job is created 502 or submitted 502, a determination of the job class is made. The determination may proceed as follows. First, a determination may be made on the amount of output consumables that will be consumed by the job. Specifically in the case of hardcopy output, the determination is made primarily on the number of sheets that will be passed through the fusing mechanism of the outputting engine. Generally, this can be predicted by predetermining the number of page impressions. Determining the amount of output consumables may be referred to as calculating 504 the job size.

A predefined job size threshold is set. The job size threshold may be set depending on the type of device and power usage factors. For example, if the device were a printer, the job size threshold may be set at 50 pages, 100 pages, etc. The determined size of the job is then compared to the threshold. If the determined size is greater than the threshold, the job is determined 506 to be a non-on-demand job and is placed on the off-peak queue 516. If the determined size is less than the threshold, the job is determined 506 to be an on-demand job. A determination 508 may then be made as to whether the user has elected to treat the job as a non-on-demand job. If so, the job is placed 516 on the off-peak job queue. This election by the user may occur and be determined by any manner, such as a user electing it as a print/copy option, a user's/department's predetermined preferences may require non-on-demand, etc.

If the user did not elect to treat the job as a non-on-demand job, an accounting incentive may be offered to the user for electing this option. If it was determined 510 that there was an accounting incentive, a user may again have the opportunity to elect 512 to treat the job as a non-on-demand job. If there was no accounting incentive, the job may be placed 514 on the regular job queue.

If the job is not classified as an off-peak job, it is placed on the regular (on-demand) queue 514. In some cases, a user may be allowed to override the classification of a job as a non-on-demand job. Typically, this would require one or more of (a) authority to do so, (b) increased fee (overuse) cost charged to the job. In the later case, the increased fee cost may be paid to the regulatory body governing power usage on the local power grid, such as a local or state agency.

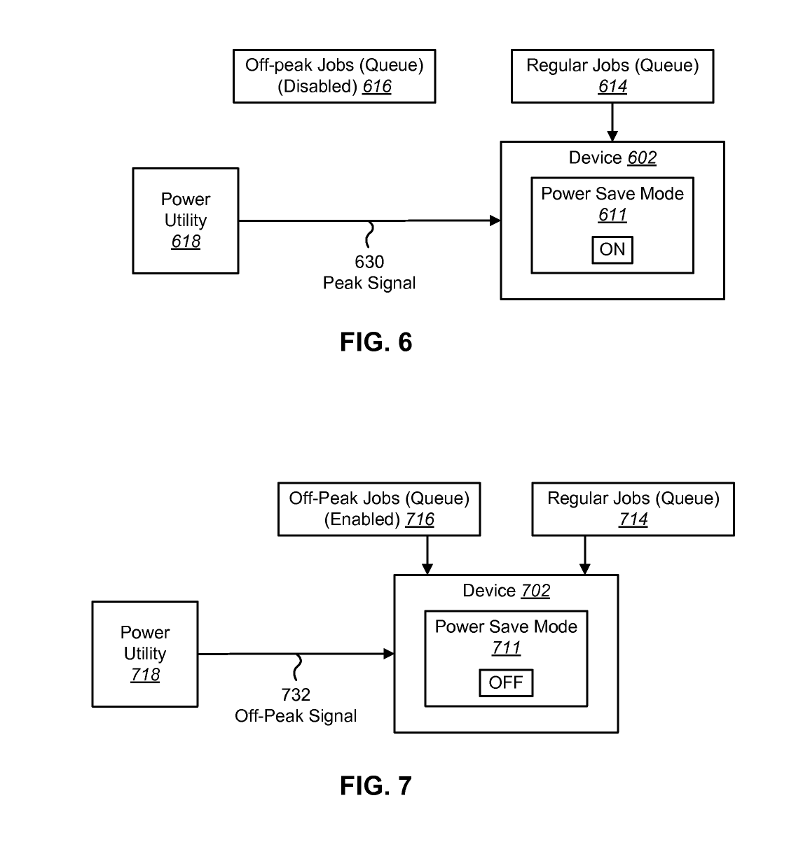

FIG. 6 is a block diagram of one configuration of an MFP device 602 operating in a peak period. During operation of the MFP 602, the peak/off-peak regulating signal 630 is sent by the power utility 618 and received through the power system connected to the local power grid. The MFP 602 or controller then decodes the signal 630. If the signal 630 is decoded as a peak period signal 630, execution of pending jobs on the off-peak queue 616 are disabled; while any currently executing job is finished. Any jobs on the regular (peak) print queue 614 may be processed immediately and without restrictions relating to power consumption. Thus, the device 602 is operating in a power save mode 611.

FIG. 7 is a block diagram of one configuration of an MFP device 702 operating in an off-peak period. If the signal from a power utility 718 is decoded as an off-peak period signal 732, execution of pending jobs on the off-peak queue 716 are allowed (enabled), as well as jobs from the regular (peak) print queue 714. Thus, the device 702 is operating when a power save mode 711 is off.

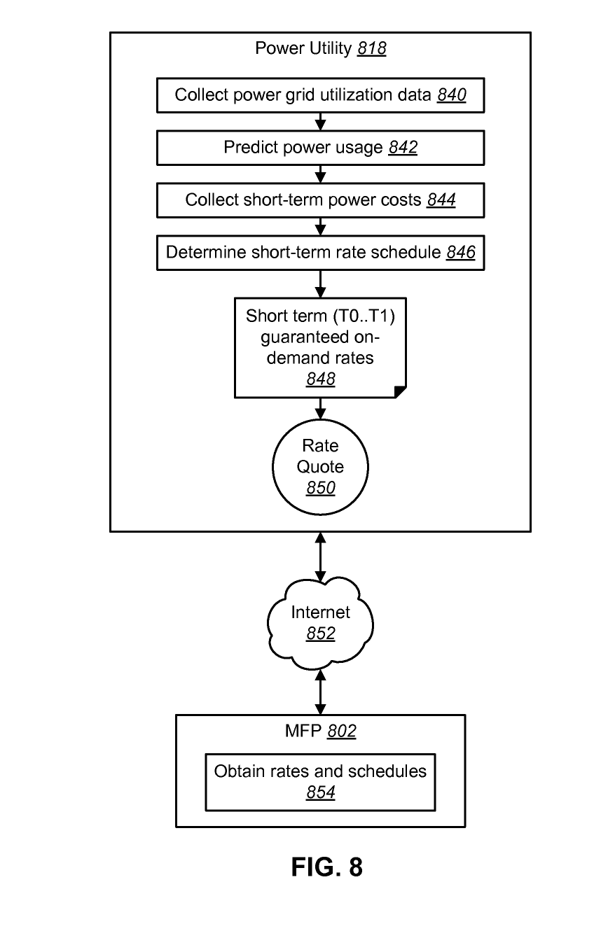

FIG. 8 is a block diagram illustrating one configuration of an MFP device 802 communicating with the power utility 818 to determine on-demand rates and schedules. The MFP 802 may communicate directly or indirectly with the power utility 818 to obtain information relating to power usage and rates. In one implementation, the MFP 802 may communicate with the power utility 818 using a server process which provides for obtaining on-demand rates/schedules for a plurality of MFP's. In the diagram shown in FIG. 8, a module 854 for obtaining rates and schedules is shown as part of the MFP 802. However, this module 854 may be part of a server, computing device or another MFP 802.

Generally, the power utility 818 would have a means to determine 846 short-term on-demand rates 848, for example over a 4 or 8 hour time period. A variety of factors may be used to determine these rates. For example, current power utilization 840 and past power utilization over the same time periods may be considered. These made be used to predict 842 power usage. Other factors may include power generation sources, their current rates and spot market rates. Short-term power costs may be collected 844 and used, such as the rates for purchasing power from another power generation source. Using this information, a process at the power company sets 846 short-term peak and off-peak rates/schedules 848 that may be guaranteed over the short-term period.

This information 848 may then be made available electronically through a rate quote process 850, such as through a web service over the Internet 852. The MFP, or managing application, can then query the power company 818 and obtain 854 these on-demand rate/schedules 848. Using this information, the MFP 802 or managing application can set its own peak and off-peak time periods, and assign jobs accordingly.

In the case of a managing application, the application may emulate the peak/off-peak signal over the internal power lines, or use another (i.e., local area network) protocol to communicate peak and off-peak times.

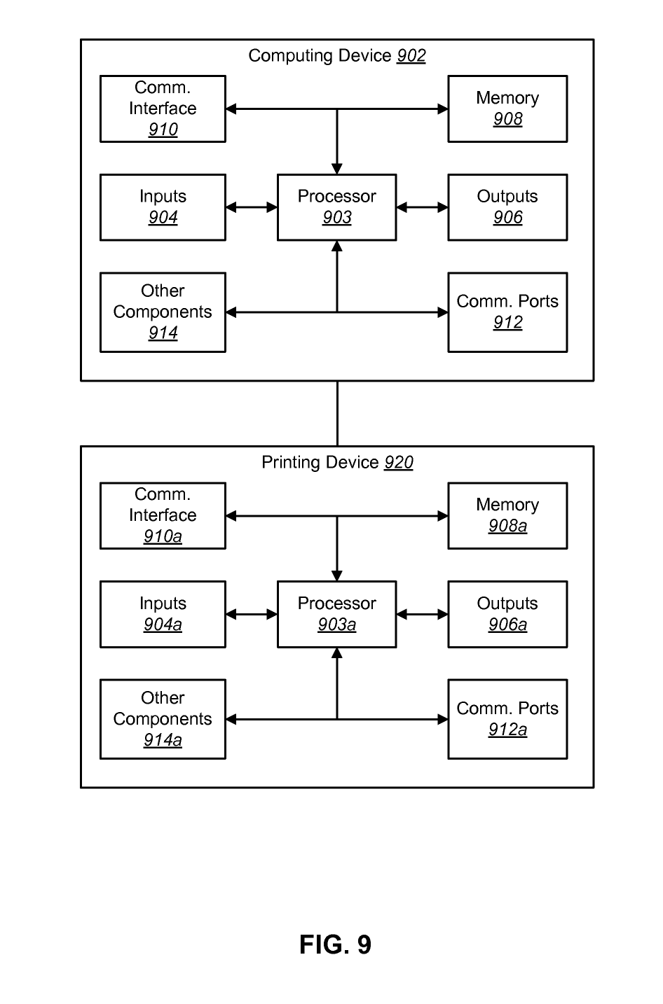

FIG. 9 is a block diagram illustrating the major hardware components that may be used with configurations herein. For example, the power regulating systems herein may be used with a printing device 920 in electronic communication with a computing device 902. The various processes herein, such as a peak/off-peak controller, the job queues, power save mode configurations, job classifier, etc., may be implemented on the printing device 920 and/or on the computing device 902.

The systems and methods disclosed may be used with a computing device 902 and a printing device 920. The major hardware components typically utilized in a computing device 902 are illustrated in FIG. 9. A computing device 902 typically includes a processor 903 in electronic communication with input components or devices and/or output components or devices. The processor 903 is operably connected to input 904 and/or output devices 906 capable of electronic communication with the processor 903, or, in other words, to devices capable of input and/or output in the form of an electrical signal. Embodiments of devices 902 may include the inputs 904, outputs 906 and the processor 903 within the same physical structure or in separate housings or structures.

The computing device 902 may also include memory 908. The memory 908 may be a separate component from the processor 903, or it may be on-board memory 908 included in the same part as the processor 903. For example, microcontrollers often include a certain amount of on-board memory.

The processor 903 is also in electronic communication with a communication interface 910. The communication interface 910 may be used for communications with other devices 902, printing devices 920, servers, etc. Thus, the communication interfaces 910 of the various devices 902 may be designed to communicate with each other to send signals or messages between the computing devices 902.

The computing device 902 may also include other communication ports 912. In addition, other components 914 may also be included in the computing device 902.

Many kinds of different devices may be used with embodiments herein. The computing device 902 may be a one-chip computer, such as a microcontroller, a one-board type of computer, such as a controller, a typical desktop computer, such as an IBM-PC compatible, a Personal Digital Assistant (PDA), a Unix-based workstation, etc. Accordingly, the block diagram of FIG. 9 is only meant to illustrate typical components of a computing device 902 and is not meant to limit the scope of embodiments disclosed herein.

The computing device 902 is in electronic communication with the printing device 920. A printing device 920 is a device that receives or transmits an imaging job, such as an MFP device or computing device. Printing devices include, but are not limited to, physical printers, multi-functional peripherals, a printer pool, a printer cluster, a fax machine, a plotter, a scanner, a copier, a logical device, a computer monitor, a file, an electronic whiteboard, a document server, a filing device, display device, audio/visual recorder/player, a media duplication device, etc. A typical printing device, such as a physical printer, fax machine, scanner, multi-functional peripheral or copier is a type of computing device. As a result, it also includes a processor, memory, communications interface, etc., as shown and illustrated in relation to FIG. 9. The printing device may be a single or a plural grouping (e.g., pool or cluster) of two or more devices.

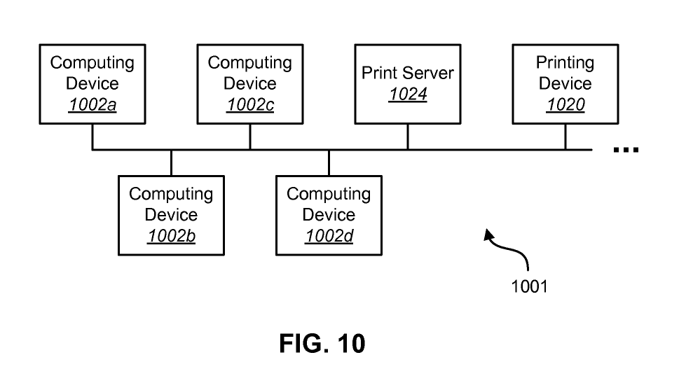

FIG. 10 is a network block diagram illustrating one possible environment in which the present systems and methods may be implemented. The various processes herein, such as a peak/off-peak controller, the job queues, power save mode configurations, job classifier, etc., may be implemented on the network 1001 or any devices shown on the network 1001.

FIG. 10 illustrates a computer network 1001 comprising a plurality of computing devices 1002, a printing device 1020 and a print server 1024.

Information and signals may be represented using any of a variety of different technologies and techniques. For example, data, instructions, commands, information, signals and the like that may be referenced throughout the above description may be represented by voltages, currents, electromagnetic waves, magnetic fields or particles, optical fields or particles or any combination thereof.

The term “determining” (and grammatical variants thereof) is used in an extremely broad sense. The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine, and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a DSP and a microprocessor, a plurality of microprocessors, one or more microprocessors in conjunction with a DSP core, or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read only memory (EPROM), electrically erasable PROM (EEPROM), flash memory, magnetic or optical data storage, registers, etc. Memory is said to be in electronic communication with a processor if the processor can read information from and/or write information to the memory. Memory may be integral to a processor and still be said to be in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

The functions described herein may be implemented in hardware, software, firmware, or any combination thereof. If implemented in software, the functions may be stored as one or more instructions on a computer-readable medium. The term “computer-readable medium” refers to any available medium that can be accessed by a computer. By way of example, and not limitation, a computer-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the embodiment that is being described, the order and/or use of specific steps and/or actions may be modified without departing from the scope of the claims.

Functions such as executing, processing, performing, running, determining, notifying, sending, receiving, storing, requesting, and/or other functions may include performing the function using a web service. Web services may include software systems designed to support interoperable machine-to-machine interaction over a computer network, such as the Internet. Web services may include various protocols and standards that may be used to exchange data between applications or systems. For example, the web services may include messaging specifications, security specifications, reliable messaging specifications, transaction specifications, metadata specifications, XML specifications, management specifications, and/or business process specifications. Commonly used specifications like SOAP, WSDL, XML, and/or other specifications may be used.

It is to be understood that the claims are not limited to the precise configuration and components illustrated above. Various modifications, changes and variations may be made in the arrangement, operation and details of the systems, methods, and apparatus described above without departing from the scope of the claims.

What is claimed is:

1. A method for controlling power usage on a device, comprising:
receiving a job at a device;
classifying the job as an on-demand job or as a non-on-demand job;
placing the job on an on-demand job queue if the job is an on-demand job;
placing the job on a non-on-demand job queue if the job is a non-on-demand job;
processing the on-demand job queue; and
processing the non-on-demand job queue only during an off-peak period.

2. The method of claim 1, further comprising receiving a peak/off-peak signal to identify a peak period or an off-peak period.

3. The method of claim 1, further comprising receiving a peak/off-peak signal from a local power grid to identify a peak period or an off-peak period.

4. The method of claim 2, further comprising decoding the peak/off-peak signal.

5. The method of claim 1, wherein the device is a multifunction peripheral device.

6. The method of claim 5, wherein the job comprises a print job, a copy job, or a facsimile job.

7. The method of claim 1, wherein classifying the job comprises calculating a job size.

8. The method of claim 7, wherein classifying the job further comprises comparing the job size with a threshold.

9. The method of claim 1, further comprising receiving rates relating to the cost of power usage via a computer network, and setting a current period as a peak period or an off-peak period based on the rates received.

10. The method of claim 1, further comprising receiving rates relating to the cost of power usage via a computer network, setting a schedule for peak periods and off-peak periods based on the rates received, and using the schedule to determine if a current period is a peak period or an off-peak period.

11. A multifunctional peripheral (“MFP”) device that is configured for power usage control, the MFP device comprising:
a processor;
memory in electronic communication with the processor;
instructions stored in the memory, the instructions being executable to:
receive a job;
classify the job as an on-demand job or as a non-on-demand job;
place the job on an on-demand job queue if the job is an on-demand job;
place the job on a non-on-demand job queue if the job is a non-on-demand job;
process the on-demand job queue; and
process the non-on-demand job queue only during an off-peak period.

12. The MFP device of claim 11, wherein the instructions are further executable to receive a peak/off-peak signal to identify a peak period or an off-peak period.

13. The MFP device of claim 11, wherein the instructions are further executable to receive a peak/off-peak signal from a local power grid to identify a peak period or an off-peak period.

14. The MFP device of claim 12, wherein the instructions are further executable to decode the peak/off-peak signal.

15. The MFP device of claim 11, wherein the job comprises a print job, a copy job, or a facsimile job.

16. The MFP device of claim 11, wherein the instructions to classify the job include instructions executable to calculate a job size.

17. The MFP device of claim 16, wherein the instructions to classify the job further include instructions executable to compare the job size with a threshold.

18. The MFP device of claim 11, wherein the instructions are further executable to download rates relating to the cost of power usage via a computer network, and set a current period as a peak period or an off-peak period based on the rates received.

19. The MFP device of claim 11, wherein the instructions are further executable to download rates relating to the cost of power usage via a computer network, set a schedule for peak periods and off-peak periods based on the rates received, and use the schedule to determine if a current period is a peak period or an off-peak period.

20. A computer-readable medium for controlling power usage on a device, the computer-readable medium comprising executable instructions for:
receiving a job at a device;
classifying the job as an on-demand job or as a non-on-demand job;
placing the job on an on-demand job queue if the job is an on-demand job;
placing the job on a non-on-demand job queue if the job is a non-on-demand job;
processing the on-demand job queue; and
processing the non-on-demand job queue only during an off-peak period.
